(19) United States
(12) Patent Application Publication
(10) Pub. No.: US 2019/0053880 A1
(43) Pub. Date: Feb. 21, 2019

(54) Cushion for dental implant

(71) Applicant: JTI Biomed Corp., Tainan (TW)

(72) Inventors: Jiin-Huey Chern LIN, Winnetka, IL (US); Chien-Ping JU, Kansas City, MO (US); Yen-Chun CHEN, Kaohsiung (TW)

(21) Appl. No.: 16/038,273

(22) Filed: Jul. 18, 2018

Related U.S. Application Data
(60) Provisional application No. 62/545,505, filed on Aug. 15, 2017.

(51) Int. Cl. A61C 8/00

(52) U.S. Cl. CPC A61C 8/0086; A61C 8/0078; A61C 8/0074; A61C 8/0039

(57) ABSTRACT

A dental implant with a cushion device that can simulate the functions of natural human periodontal ligament (PDL) is provided.

### FIELD OF THE INVENTION

The present invention is related to a cushion design for a dental implant, which mimics the functions of human periodontal ligament (PDL).

### BACKGROUND OF THE INVENTION

The periodontal ligament (PDL) is a thin layer of dense soft connective tissue interposed between tooth root and alveolar bone (Berkovitz et al., 1995). The PDL has a determinant influence on tooth instantaneous and short-term mobility, because of the much lower stiffness in comparison with the surrounding alveolar bone (Mühlemann, 1960). This initial tooth mobility, which has to be distinguished from the long-term orthodontic tooth movement, is affected by the mechanical characteristics of the different components building up the PDL, i.e. the fibrous tissues, the fluid phase, the vasculature, the innervation and the cells within the periodontal space. However, the PDL also influences tooth long-term movement, and its strain state regulates the activity of cells in the periodontal space, that are involved in alveolar bone remodeling processes (Katona et al., 1995; Kawarizadeh et al., 2004; Roberts et al., 2004).

Depending on the individual treated with orthodontic appliances and force systems, orthodontic tooth movement starts after a retardation phase of several hours up to several days during which the cell activity is triggered by a chain of biological factors (Ziros et al., 2002; Kawarizadeh et al., 2005). In contrast to that, initial tooth mobility covers damping effects during short-term phenomena below or around seconds, such like chewing or grinding, medium effects around several seconds to minutes during clenching and long-term effects after the application of an orthodontic force system, prior to the initiation of bone remodeling processes. In all the above-mentioned cases the tooth will move back into its initial position if the force is released (Mühlemann, 1960), as the biological chain triggering the bone remodeling phenomena has not yet been initiated. However, due to the complex structure of PDL, the force/deflection characteristics differ significantly with respect to loading time. The mechanical properties of the PDL are essential for tooth mobility, both in the deformation of the PDL itself and in the cellular activity of the PDL involving bone resorption/apposition.

In general, the extracellular matrix of soft connective tissues is composed of ground substance and fibrous structures, such as elastin and collagen (Cowin, 2000). The ground substance is mainly composed of water, proteoglycans and glycoproteins. It strongly affects tissue stiffness in compression because of its high liquid content and visco-elastic behavior depending on fluid flux within fibrous structures. Elastin develops a three-dimensional fibrous network characterized by random distribution. Collagen fibers are principally responsible for tissue tensile stiffness. They are oriented along specific directions to withstand the effects of applied loading and determine tissue anisotropic behavior.

As mentioned above, in natural teeth the PDL functions as a cushion between tooth and jawbone, absorbing impact force and uniformly transferring occlusal forces to surrounding bone. The distribution of the force depends on micro-movement induced by the PDL. Due to lack of PDL, dental implant has to directly bond to bone, causing non-uniform stress distribution in bone which might lead to implant failure (Quirynen et al., 1992). Because of the lack of micro-movement of implants, most of the force distribution is concentrated at the crest of the ridge. Vertical forces at the bone interface are concentrated at the crestal regions, and lateral forces increase the magnitude of the crestal force distribution.

The most common failure mode of dental implant is loosening of implant induced by the atrophy of surrounding jawbone, which is generally caused by improper stress distribution on cervical bone under occlusion or mastication loading. Overloading and stress shielding have often been cited as the primary biomechanical factors leading to marginal bone loss around implants (Akça et al., 2010). Whether the bone loss after implantation is due to overloading or stress shielding still needs to be clarified. No matter which effect (overstressing or stress shielding) dominates the long-term performance of dental implant, it seems logical that excessive stress concentrations plays a critical role in early-stage marginal bone loss process.

Overloading has been identified as a primary factor behind dental implant failure. The peak bone stresses normally appear in the marginal bone. The anchorage strength is maximized if the implant is given a design that minimizes the peak bone stress caused by a standardized load. The design of the implant-abutment interface has a profound effect upon the stress state in the marginal bone when this reaches the level of this interface. An article of Sun (2003) mentioned that the human average biting force of first permanent molars is 80-90N with a peak force that may exceed 100N.

For cushion purposes, US 2010/0304334 A1 discloses a dental implant system comprising an implant having a well and an abutment having a post shaped to be received in the tapered well, and in one embodiment shown thereof the implant and the abutment are jointed one to the other with a retentive elastomeric product, enabling an artificial tooth supported by the abutment to move in a fashion similar to that of a natural tooth.

The inventors of the present application in their previous work (WO 2013/169569 A1) disclose a dental implant comprising: a substantially cylindrical hollow base member comprising a wall defining a space in said substantially cylindrical hollow base member, and a plurality of through-thickness holes communicating said space with an outer surface of said wall; an abutment; an implant-abutment junction (IAJ) portion at one end of said base member to retain said abutment to said base member, so that said abutment is able to move within a predetermined distance along an axial direction of said base member; and a first cushion adapted to be mounted between said abutment and said base member for providing a resistance force when said abutment is pressed to move relatively toward said base member and providing a bouncing back force when said abutment is released from said pressing. In one embodiment of the cushioned dental implant, the dental implant further comprises a second cushion which is an elastomer and is sandwiched between said IAJ portion and said abutment. The disclosure of PCT/US2013/039366 is incorporated herein by reference.

The first cushion and/or the second cushion are able to provide a resistance force when said abutment is pressed to move relatively toward said base member and providing a bouncing back force when said abutment is released from said pressing. Further, the double-cushioned dental implant in comparison with the single-cushioned dental implant shows a far superiority in a fatigue resistance test.

Despite its complicated biological, morphological and biomechanical behavior of PDL, many theories of which are still unclear, as mentioned above, it is clinically well known that PDL is characterized by its highly non-linear mechanical response (Mühlemann, 1951; Mühlemann, 1960; Walter et al., 1998; Ona and Wakabayashi, 2006). In their study of influence of alveolar bone support on the functional capability of a tooth, Ona and Wakabayashi (2006) found that the material property of the PDL was determined in the linear elastic and the non-linear elastic phases. And the sample of normal bone height with normal and widened PDL space, and those reduced bone height with normal and widened PDL space were demonstrated in their different load-deflection profiles.

As early as 1951, in-vivo load-displacement data in PDL of human incisor teeth were obtained in the classic article of Mühlemann (1951). The author found that the tooth mobility (TM) under horizontal force could be divided into three substantially linear ranges: initial TM (or desmodontal TM), intermediate TM (or periodontal TM) and terminal TM, as indicated in FIG. 4 in Mühlemann (1951). Within the initial TM, the resistance of the tooth against the force (the load-displacement slope or elastic modulus) was very small. When the load was increased to a certain level (around 100 gm), the resistance suddenly increased and entered into the intermediate TM. Within the range about 100-1500 gm, the increase in motion remained in linear relation to the increase in force, beyond that pain was registered (entering into terminal TM). It was demonstrated in the same article that initial TM was absent in the test with replanted teeth where the desmodontal fibers no longer existed, as indicated in FIG. 5 in Mühlemann (1951). In other words, the cushion effect observed in natural teeth was absent in the replanted teeth without the desmodont.

The absence in desmodontal TM (cushion) was also demonstrated in the study of Richter et al., (Richter et al., 1990) of a human molar under vertical load. In this study the human tooth displacement-vertical load profile, again, dearly displayed two distinctively different linear ranges (desmodontal TM and periodontal TM). The displacement-vertical load profile of an osseointegrated rigid dental implant, however, demonstrated only a linear periodontal TM apparently in the absence of the cushioned desmodontal TM. All conventional artificial dental implant, no matter metallic or ceramic, which are directly implanted in alveolar bone without desmodont, belong to this non-cushioned category.

Richter et al. (1990) indicates that the load-displacement profile has two distinctively different slopes. The slope in the first linear region is 11.8 μm/N and the slope in the second linear region is 1.1 μm/N as shown in FIG. 1 thereof. FIG. 2 of Richter et al. (1990) indicates that the load-displacement profile has only one slope, 2.1 μm/N, in the entire region.

Despite our WO 2013/169569 A1 and WO 2015/066438 A1 disclose a single or double-cushioned dental implant, they did not teach how to make a cushion that can simulate human PDL which demonstrates in-vivo at least two (initial and intermediate) distinctively different stress-strain slopes (moduli) when loaded.

### SUMMARY OF THE INVENTION

A primary purpose of this invention is to disclose a cushion device that can simulate the functions of natural human periodontal ligament (PDL), when it is incorporated to a dental implant. This cushion device, with specified design parameters disclosed in the specification, largely simulates the cushion function of the natural human periodontal ligament. This is achieved by installing a composite cushion or multiple cushions made from materials having different modulus (stiffness) values and/or different thicknesses. This new cushioned dental implant design may lead to a paradigm shift from “being effective” to “being comfortable” for patients with dental implants.

### The Unique Features of Our Inventive Design

One critical factor leading to dental implant loosening is the non-uniform occlusive force on the root. In natural teeth the periodontal ligament functions as a cushion/buffer between tooth and jawbone, absorbing impact force and uniformly transferring occlusal forces to surrounding bone. Due to lack of periodontal ligament, the conventional dental implant has to directly bond to bone, causing non-uniform stress distribution in bone. This cushion design largely reduces the non-uniform stress distribution in alveolar bone (avoiding stress-concentrated spots) and absorbs stresses more uniformly and effectively
This cushion design, with specified design parameters disclosed in the specification, largely simulates the cushion function of the natural human periodontal ligament.
The cushion design may be applied to a single-cushion dental implant or a double-cushion dental implant.
This new design may lead to a paradigm shift from “being effective” to “being comfortable” for patients with dental implants.

### BRIEF DESCRIPTION OF THE DRAWINGS

Preferred embodiments of the present invention will be described in the following with the accompanying drawings, wherein like elements/parts are presented by like numerals.

FIG. 1 shows a cross-sectional view of a dental implant constructed in accordance with a first preferred embodiment of the present invention.

FIG. 2 shows a cross-sectional view of a dental implant constructed in accordance with a second preferred embodiment of the present invention.

FIG. 3A shows a cross-sectional view of a dental implant constructed in accordance with a third preferred embodiment of the present invention.

FIG. 3B shows a cross-sectional view of a dental implant constructed in accordance with a fourth preferred embodiment of the present invention.

FIG. 4 shows a cross-sectional view of a compressive testing set-up for determining the slope of a stress-strain profile (μm/N), which may be transformed into compressive modulus (MPa).

FIG. 5 is a plot showing the results of compressive testing on single cushions (sample code, SP) (the second cushion 40 in FIG. 4) with different heat treatment conditions and/or different initial thicknesses, wherein - represents results of human molar (11.8 μm/N, 1.1 μm/N); -▪- represents an initial cushion thickness of 1.3 mm and heat treatment of 225° C., 4h (28.2 μm/N); -▾- represents an initial cushion thickness of 5 mm and heat treatment of 225° C., 4h (60.7 μm/N); -□- represents an initial cushion thickness of 0.3 mm and heat treatment of 225° C., 8h (0.1 μm/N); and -•- represents an initial cushion thickness of 0.8 mm and heat treatment of 210° C., 2h (560.7 μm/N).

FIG. 6 is a plot showing the results of compressive testing on double cushions (sample code, SP) with same material and different thicknesses, wherein - represents results of human molar (11.8 μm/N, 1.1 μm/N); -▪- represents an outer cushion thickness of 0.3 mm and an inner cushion thickness of 1.2 mm (10.3 μm/N, 3.1 μm/N); -♦- represents an outer cushion thickness of 1.0 mm and an inner cushion thickness of 1.0 mm (30.8 μm/N); - [symbol] - represents an outer cushion thickness of 0.8 mm and an inner cushion thickness of 0.8 mm (20.6 μm/N); and -•- represents an outer cushion thickness of 0.5 mm and an inner cushion thickness of 0.8 mm (15.1 μm/N, 8.8 μm/N).

FIG. 7 is a plot showing the results of compressive testing on double cushions with different materials and same thicknesses (0.5 mm), wherein - represents results of human molar (11.8 μm/N, 1.1 μm/N); -▪- represents an outer cushion of sample code Ca and an inner cushion of sample code WS (8.3 μm/N, 2.8 μm/N); -▴-represents an outer cushion of sample code SP and an inner cushion of sample code WS (21.2 μm/N, 11.1 μm/N); and -▾- represents an outer cushion of sample code Ca and an inner cushion of sample code DT (16.8 μm/N, 3.3 μm/N).

FIG. 8 is a plot showing the results of compressive testing on single cushions with same material and different thicknesses, wherein - represents results of human molar (11.8 μm/N, 1.1 μm/N); -▪- represents an outer cushion of sample code C6-265 having a thickness of 0.35 mm (2.8 μm/N); -•- represents an outer cushion of sample code C6-265 having a thickness of 0.30 mm (2.0 μm/N); -▾- represents an outer cushion of sample code C6-265 having a thickness of 0.2 mm (1.7 μm/N); and -♦- represents an inner cushion of sample code C6-265 having a thickness of 0.1 mm (0.3 μm/N).

FIG. 9 is a plot showing the results of compressive testing on double cushions with same material (sample code of C6-265) and different thicknesses, wherein - represents results of human molar (11.8 μm/N, 1.1 μm/N); -•- represents an inner cushion thickness of 0.2 mm and an outer cushion thickness of 0.35 mm (14.5 μm/N, 2.1 μm/N); -▴- represents an inner cushion thickness of 0.2 mm and an outer cushion thickness of 0.30 mm (7.2 μm/N, 1.8 μm/N); and -*- represents an inner cushion thickness of 0.1 mm and an outer cushion thickness of 0.20 mm (8.3 μm/N, 1.4 μm/N).

### DETAILED DESCRIPTION OF THE INVENTION

The present invention includes the following aspects (but not limited thereto):

1. A dental implant comprising:

a base member;

an abutment;

an implant-abutment junction (IAJ) portion at one end of said base member to retain said abutment to said base member, so that said abutment is able to move within a predetermined distance along an axial direction of said base member; and

a cushion means for providing a resistance force when said abutment is pressed to move relatively toward said base member in said axial direction and providing a bouncing back force when said abutment is released from said pressing,

wherein the cushion means simulates functions of natural human periodontal ligament (PDL).

2. The dental implant of aspect 1, wherein the dental implant shows at least two different slopes in an axial load-displacement profile when compressed, wherein a first slope simulates desmodontal tooth movement, and a second slope simulates periodontal tooth movement of a human natural tooth.

3. The dental implant of aspect 2, wherein the first slope is in a range from about 2 to 20 μm/N, preferably 5 to 20 μm/N and more preferably 7 to 15 μm/N; and the second slope is in a range from about 0.1 to 10 μm/N; preferably 0.3 to 6 μm/N and more preferably 0.6 to 3 μm/N, wherein the first slope is greater than the second slope.

4. The dental implant of aspect 1, wherein the dental implant shows a vertical load-displacement profile with at least two different compressive modulus values when compressed, wherein a first modulus simulates desmodontal tooth movement, and a second modulus simulates periodontal tooth movement of a human natural tooth.

5. The dental implant of aspect 4, wherein the first modulus is in a range from about 0.3-40 MPa, preferably about 0.4-20 MPa, and more preferably 1.0-10 MPa; and the second modulus is in the range from about 0.7-550 MPa, preferably about 0.9-100 MPa and more preferably about 1.0-50 MPa, wherein the second modulus is greater than the first modulus.

6. The dental implant of aspect 1, wherein the cushion means comprises: a first cushion sandwiched between said IAJ portion and said abutment;

a second cushion sandwiched between said abutment and said base member only in said axial direction; and

wherein the first cushion and the second cushion are two separate members,

wherein the first cushion and the second cushion have different modulus values or different thicknesses or different modulus values and different thicknesses.

7. The dental implant of aspect 6, wherein the first cushion and the second cushion are made from different elastic materials having different modulus values, wherein the first cushion has a compressive modulus about 0.3-40 MPa, preferably about 0.4-20 MPa, and more preferably 1.0-10 MPa; and the second cushion has a compressive modulus in the range from about 0.7-550 MPa, preferably about 0.9-100 MPa, and more preferably about 1.0-50 MPa, wherein the first cushion and the second cushion both have a thickness about 0.1 mm-about 1.0 mm.

8. The dental implant of aspect 7, wherein the first cushion and the second cushion both have a same thickness, and the first cushion has a compressive modulus less than that of the second cushion.

9. The dental implant of aspect 6, wherein the first cushion and the second cushion have different thicknesses and are made from a same elastic material having a compressive modulus about 0.3-500 MPa, preferably about 0.4-100 MPa, and more preferably 1.0-50 MPa; wherein the first cushion has a thickness greater than that of the second cushion, wherein the first cushion has a thickness about 0.2 mm-1.0 mm, preferably 0.3 mm-0.8 mm, while the second cushion has a thickness about 0.1 mm-0.6 mm, preferably 0.2 mm-0.4 mm.

10. The dental implant of aspect 1, wherein the cushion means comprises:

a second cushion sandwiched between said abutment and said base member only in said axial direction; and

wherein the second cushion is a composite cushion comprising materials having different modulus values.

11. The dental implant of aspect 10, wherein the second cushion is a lamellar-type composite cushion comprising two layers of different elastic materials, wherein one layer has a compressive modulus about 0.3-40 MPa, preferably about 0.4-20 MPa, and has a thickness about 0.1-1.0 mm, preferably about 0.2-0.8 mm, while another layer has a compressive modulus about 0.5-500 MPa, preferably about 1.0-100 MPa, and has a thickness about 0.1-1.0 mm, preferably about 0.2-0.8 mm.

12. The dental implant of aspect 11, wherein said one layer is closer to said abutment than said another layer, and said one layer has a compressive modulus less than that of said another layer.

13. The dental implant of aspect 1, wherein the cushion means comprises:

a first cushion sandwiched between said IAJ portion and said abutment; and

wherein the first cushion is a composite cushion comprising materials having different modulus values.

14. The dental implant of aspect 13, wherein the first cushion is a lamellar-type composite cushion comprising two layers of different elastic materials, wherein one layer has a compressive modulus about 0.3-40 MPa, preferably about 0.4-20 MPa, and has a thickness about 0.1-1.0 mm, preferably about 0.2-0.8 mm, while another layer has a compressive modulus about 0.5-500 MPa, preferably about 1.0-100 MPa, and has a thickness about 0.1-1.0 mm, preferably about 0.2-0.8 mm.

15. The dental implant of aspect 13, wherein said one layer is closer to said abutment than said another layer, and said one layer has a compressive modulus less than that of said another layer.

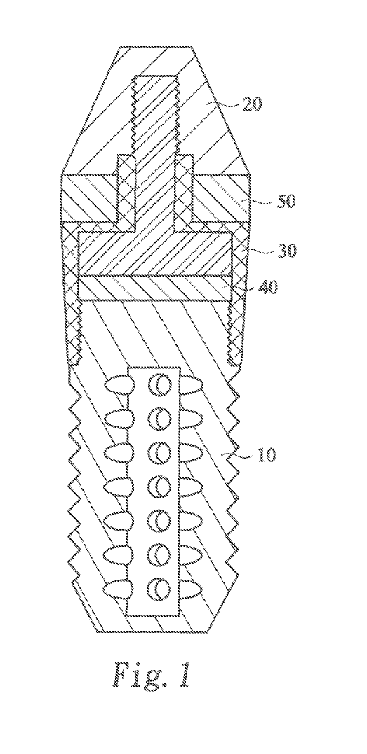

A dental implant constructed in accordance with a first preferred embodiment of the present invention is shown in FIG. 1, which comprises

a base member 10;

an abutment 20;

an implant-abutment junction (IAJ) portion 30 at one end of said base member 10 to retain said abutment 20 to said base member 10, so that said abutment 20 is able to move within a predetermined distance along an axial direction of said base member 10;

a first cushion 50 sandwiched between said IAJ portion 30 and said abutment 20,

a second cushion 40 sandwiched between said abutment 20 and said base member 10 only in said axial direction.

### The Advantages of Our Inventive Design

The micromotion provided by the cushions, contributes towards a more natural function of the implant, rendering it an improved tooth-replacement. It promotes a more natural bite feel, and an enhanced interaction with the surrounding teeth. In addition, it enables the implementation of fixed bridging supported by a combination of an implant and a tooth, which is traditionally endangered by the discrepancy of the amount of micromotion exhibited by the tooth and the implant. However, perhaps the most prominent advantage of the implant with cushions is minimizing the amount of micromotion transferred from the bite load to the connecting interface between the implant and the surrounding bone, especially in the early stages of implantation where excessive micromotion at the root-form leads to fibrous encapsulation. (Werner et al., 2012)

### Double-Cushion Design

For double-cushion design, although interchangeable, preferably the first (outer) cushion is a thicker, softer (lower modulus/less stiff), near-abutment donut-shaped cushion, and the second (inner) cushion is a thinner, harder (higher modulus/stiffer), near-root cushion.

### Load-Displacement Slope

A cushioned dental implant with multiple cushions [Note: Double-cushion design is preferred], wherein the cushion(s) simulating natural PDL, has a vertical load-displacement profile with at least two different slopes (the “first slope” representing desmodontal TM, and the “second slope” representing periodontal TM) when compressed; wherein the first slope is in the range from about 2 to 20 μm/N, preferably 5 to 20 μm/N and more preferably 7 to 15 μm/N; and the second slope is in the range from about 0.1 to 10 μm/N; preferably 0.3 to 6 μm/N and more preferably 0.6 to 3 μm/N.

### Modulus

A cushioned dental implant with multiple cushions, wherein the cushion(s) simulating natural PDL, has a vertical load-displacement profile with at least two different compressive modulus values (the “first modulus” representing desmodontal TM, and the “second modulus” representing periodontal TM) under compressive loading; wherein the first modulus is in the range from about 0.3-40 MPa, preferably about 0.4-20 MPa, and more preferably 1.0-10 MPa; and the second modulus is in the range from about 0.7-550 MPa, preferably about 0.9-100 MPa, and more preferably about 1.0-50 MPa.

### Thickness

For a double-cushion dental implant, the two cushions can be made from different elastic materials having different moduli; or one or both cushions are composite cushions; or the two cushions having different thicknesses (even made from the same elastic material), therefore resulting in a vertical load-displacement profile with at least two different slopes (and different modulus values (desmodontal TM and periodontal TM).

For double-cushions having different thicknesses made from the same material, although interchangeable, preferably the first (soft, near-abutment) cushion is thicker than the second (stiffer, near-root) cushion.

[NOTE: For two cushions with different thicknesses made from the same material, the thinner cushion has a larger load-displacement slope]

For the double-cushion dental implant wherein the two cushions are made from different elastic materials having different modulus values, the first cushion has a compressive modulus about 0.3-40 MPa, preferably about 0.4-20 MPa, and more preferably 1.0-10 MPa; and the second cushion has a compressive modulus in the range from about 0.7-550 MPa, preferably about 0.9-100 MPa, and more preferably about 1.0-50 MPa. Each cushion has a thickness about 0.1 mm-1.0 mm.

For a double-cushion dental implant wherein the two cushions have different thicknesses and are made from the same elastic material, the first (soft, near-abutment) cushion has a thickness larger than the second (stiffer, near-root) cushion. The first cushion has a thickness about 0.2 mm-1.0 mm, preferably 0.3 mm-0.8 mm, while the second (stiffer, near-root) cushion has a thickness about 0.1 mm-0.6 mm, preferably 0.2 mm-0.4 mm.

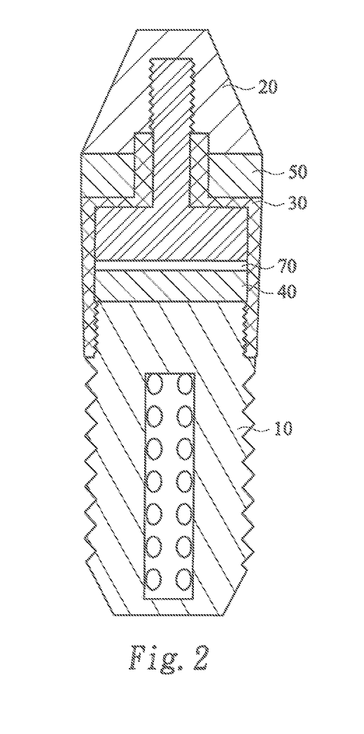

For the double-cushion device, optionally there exists a space (gap) with a spacing of about 5-50 μm, preferably 10-30 μm, between the second cushion (the stiffer, near-root cushion) and an abutment to be pressed on the second cushion when the dental implant is compressed (Note: This is for further enhancing its similarity in load-displacement profile to natural teeth). This design is shown in FIG. 2, wherein a space (gap) 70 exists between the second cushion 40 and the bottom of the abutment 20.

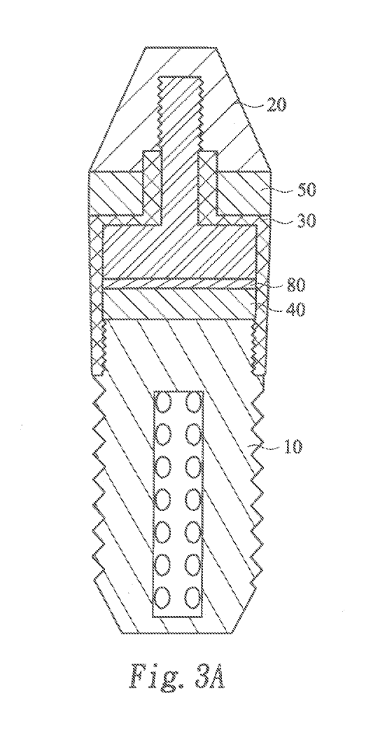

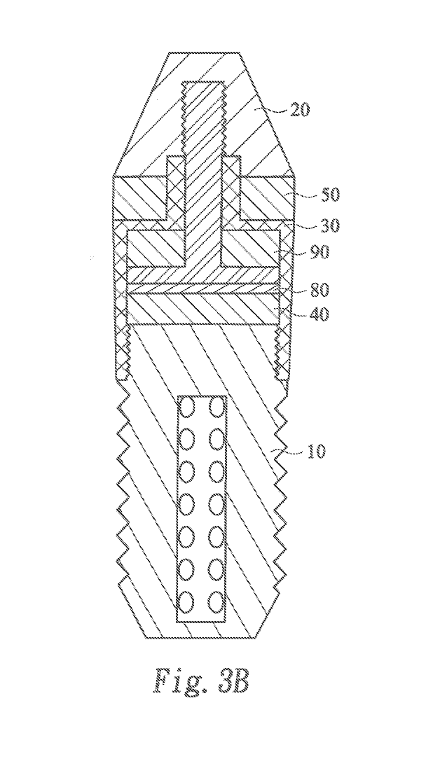

For the double-cushion device, optionally there inserts an elastic layer of soft (low modulus) membrane with a thickness of about 5-50 μm, preferably 10-30 μm, between the second cushion (the stiffer, near-root cushion) and the abutment. This design is shown in FIG. 3A, wherein an additional elastic layer of soft (low modulus) membrane 80 sandwiched between the second cushion 40 and the bottom of the abutment 20. Further optionally there inserts an additional soft (low modulus) cushion 90 similar to the first cushion 50 between the IAJ portion 30 and the abutment 20, as shown in FIG. 3B.

[Note: This membrane should have a modulus similar to or lower than the first cushion modulus]
[Note: This is for further enhancing its similarity in load-displacement profile to natural teeth]
[Note: This design may be easier to fabricate than the above “space between the second cushion and the abutment” design shown in FIG. 2]

Cushion shape can be solid round, ring, flat, porous, etc.

The cushion is an elastomer, preferably a rubber and more preferably a silicone-based rubber. The elastomer may further comprise modulus-enhancing modifiers, such as ceramic, metallic or glass particles, whiskers or short fibers, carbon fiber, carbon black, CNT, graphite, carbon black, activated carbon, etc.

### Single-Cushion Design

For the single-cushion design, the cushion is made of a composite material comprising at least two elastic materials with distinctively different compressive stress-strain modulus values; wherein the composite can be lamellar (at least two flat layers of different modulus values), particulate (one matrix and at least one particular reinforcement), or columnar (multiple columns with at least two different elastic materials with distinctively different modulus values), therefore resulting in a vertical load-displacement profile with at least two different slopes (desmodontal TM and periodontal TM).

For the lamellar-type single cushion comprising two different elastic materials (two flat layers), one layer has a compressive modulus about 0.1-10 MPa, preferably about 0.5-5 MPa, while the other layer has a compressive modulus 1-500 MPa, preferably 5-100 MPa.

Although interchangeable, preferably the soft (low modulus) layer is the near-abutment layer.

### Method of Making an Elastic Cushion for Dental Implant

In order to adjust (usually to increase) the modulus (stiffness) of an elastic silicone-based cushion material (no matter commercially available or in-house made), a heat treatment at >150° C. for >0.1h, preferably at about 200-300° C. for about 0.1-24 h, and more preferably at about 210-250° C. for about 1-12h, is applied to the raw cushion material. This heat treatment may be either applied to the cushion material before shaping/forming into a final product, or applied to the cushion already formed into its final shape. Different thicknesses of cushions may be obtained by either rolling/compressing or directly cutting into different thicknesses.

[Note: Generally a thinner cushion had a larger load-displacement slope than a thicker cushion of the same material]

### Materials Used for Tests

Table 1 lists the commercial silicone-based materials with different modulus values with or without heat treatment used for tests.

TABLE 1

| Manufacturer/ | | | Code of |
|---|---|---|---|
| Company, Country | Product name/type | Material | sample |
| Dow Corning, USA | DOW CORNING ® | Silicone | C6-265 |
| | C6-265 | elastomer | |
| | ELASTOMER | | |
| Perfect Medical | Catheter | Silicone complex | Ca |
| Industry, Vietnam | | | |
| Perfect Medical | Drainage tube | Silicone complex | DT |
| Industry, Vietnam | | | |
| MISUMI Corp., Japan | White silicone | Silicone | WS |
| Wacker Chemie AG, | Stirring plate | Wacker Silicone | SP |
| Germany | | 70 | |

[Note: Dow Corning C6-265 is a USP Class V medical grade material which has passed biocompatibility test and is referenced in FDA 21 CFR 177.2600 as “Substances for Use Only as Components of Articles Intended for Repeated Use”]

### Method of Making a Silicone Rubber Sheet (Cushion) for Tests

To prepare a series of cushions with different modulus values for tests, a medical grade silicone (Wacker Chemie AG, Germany) was heat-treated to different temperatures for different periods of time. [Note: Within the present temperature and time ranges, a higher temperature and/or longer time generally resulted in a higher modulus]. An appropriate amount of the silicone was placed between two acrylic plates which were coated with a layer of petrolatum for lubrication purpose. The silicone was then placed in a furnace at different temperatures for different periods of time to obtain different levels of modulus (stiffness), followed by cooling in air. The thickness of the silicone rubber sheet was controlled by controlling the space between the two acrylic plates.

### Compressive Test of Cushions

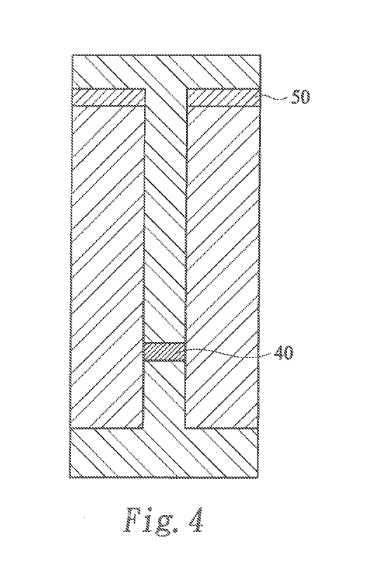

The compressive testing was conducted using a Shimadzu universal testing machine (Autograph AG-X 10 kN, Shimadzu, Japan) at a constant crosshead speed of 1 mm/min. The compressive testing set-up is shown in FIG. 4, wherein the first cushion is designated by a numeral of 50 (donut-shape with an outside diameter of 50 mm and an inside diameter of 30 mm) and the second cushion is designated by a numeral of 40 (round-shape with a diameter of 30 mm). Data analysis was conducted using an Origin system (OriginPro8, OriginLab Corp., USA) to determine the slope of a stress-strain profile (μm/N), which may be transformed into compressive modulus (MPa).

TABLE 2
Materials, manufacturers, initial thicknesses, heat treatment conditions,
compressive load-displacement slopes and compressive modulus values of cushions

| Sample code/ | Initial sample | 1^{st} load- | 1^{st} | 2^{nd} load/ | 2^{nd} |
|---|---|---|---|---|---|
| heat treatment | thickness | displacement | modulus | displacement | modulus |
| condition | (mm) | slope (μm/N) | (MPa) | slope (μm/N) | (MPa) |
| SP/210° C., 2 h | 0.8 | 560.7 | 0.004 | N/A | N/A |
| SP/225° C., 4 h | 5 | 60.7 | 0.2 | N/A | N/A |
| SP/225° C., 4 h | 1.3 | 28.2 | 0.1 | N/A | N/A |
| SP/225° C., 8 h | 0.3 | 0.1 | 5.9 | N/A | N/A |
| Double SP | 1 + 1 | 30.8 | 1.7 | N/A | N/A |
| Double SP | 0.8 + 0.8 | 20.6 | 2.0 | N/A | N/A |
| Double SP | 0.5 + 0.8 | 15.1 | 2.7 | 8.8 | 4.6 |
| Double SP | 0.3 + 1.2 | 10.3 | 5.9 | 3.1 | 19.9 |
| SP + WS | 0.5 + 0.5 | 21.2 | 1.2 | 11.1 | 2.3 |
| Ca + WS | 0.5 + 0.5 | 8.3 | 3.1 | 2.8 | 9.0 |
| Ca + DT | 0.5 + 0.5 | 16.8 | 1.5 | 3.3 | 7.8 |
| Double C6-265 | 0.2 + 0.1 | 8.3 | 1.2 | 1.4 | 7.1 |
| Double C6-265 | 0.3 + 0.2 | 7.2 | 2.1 | 1.8 | 8.3 |
| Double C6-265 | 0.35 + 0.2 | 14.5 | 1.2 | 2.1 | 8.4 |
| C6-265 | 0.35 | 2.8 | 31.5 | N/A | N/A |
| C6-265 | 0.3 | 2.0 | 37.5 | N/A | N/A |
| C6-265 | 0.2 | 1.7 | 28.9 | N/A | N/A |
| C6-265 | 0.1 | 0.3 | 45.8 | N/A | N/A |

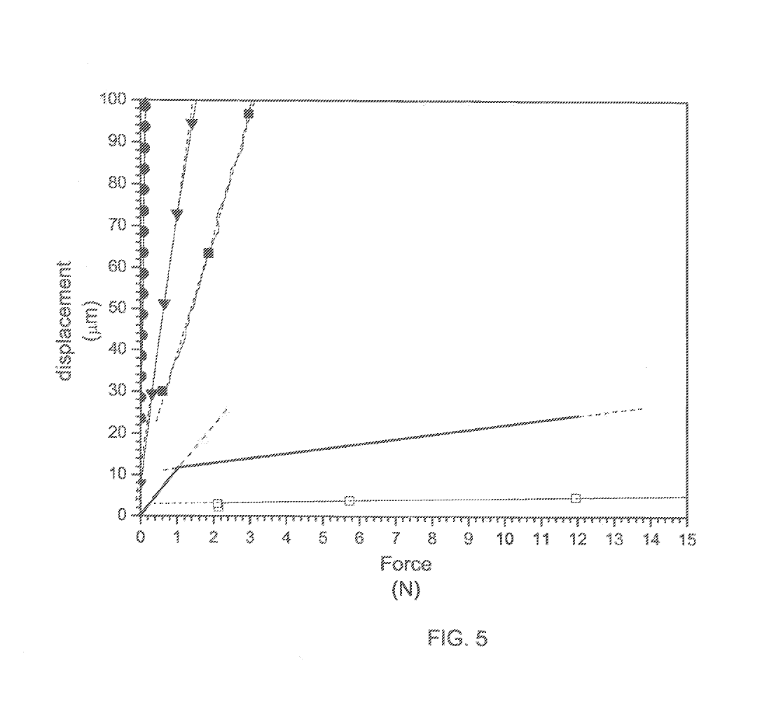

FIG. 5 shows the results of compressive testing on single cushions (the second cushion 40) with different heat treatment conditions and/or different initial thicknesses, and the results show:
(1) Each profile has substantially one slope.
(2) Within the test range, a higher heating temperature and/or longer heating time results a stiffer (larger load-displacement slope or higher modulus) cushion.
(3) The load-displacement profile of the cushion may be manipulated to simulate that of human PDL with proper heat treatment.

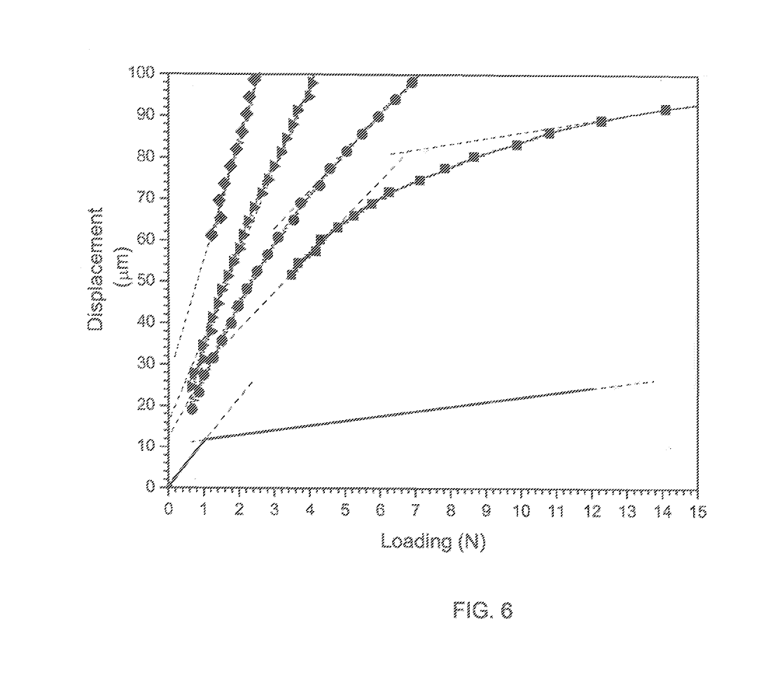

FIG. 6 shows the results of compressive testing on double cushions with same material and different thicknesses, and the results show:
(1) Double cushions with same thickness result in one-slope profiles. Double cushions with different thicknesses result in two-slope profiles.
(2) The thinner cushion results in the stiffer cushion
(3) Some profiles shown in this figure are close to the first slope (initial TM) of human PDL, but all are far less stiff than the second slope of human PDL.

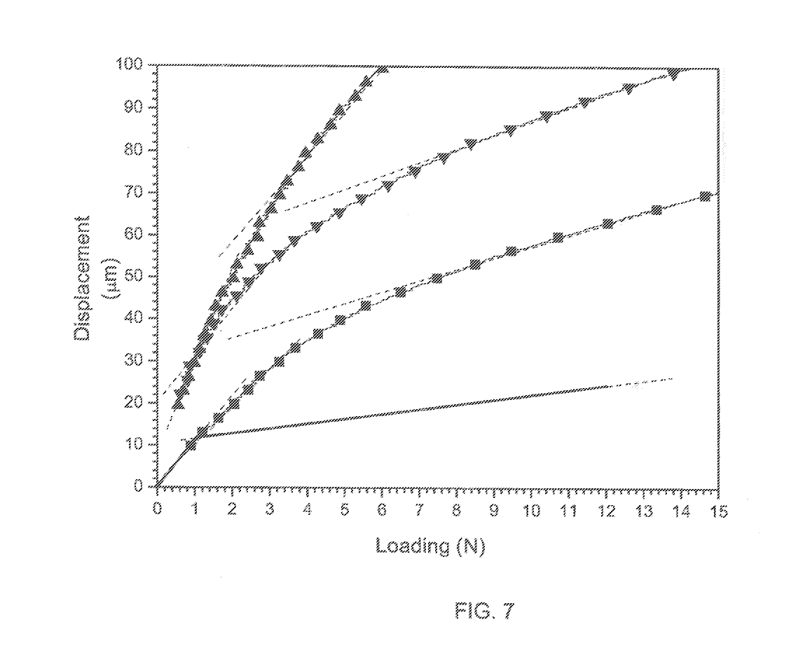

FIG. 7 shows the results of compressive testing on double cushions with different materials and same thicknesses, and the results show:
(1) Each profile has substantially two slopes.
(2) The first slope of “Ca(o)+WS(i)” profile is close to the first slope of human PDL, and its second slope is close to the second slope of human PDL.

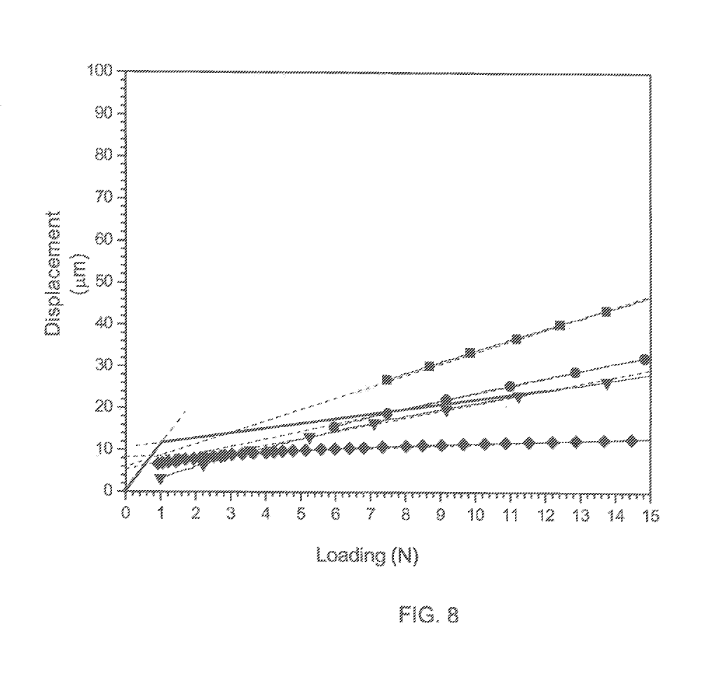

FIG. 8 shows the results of compressive testing on single cushions with same material and different thicknesses, and the results show:
(1) Each profile has substantially one slope.
(2) The thinner cushion results in the stiffer cushion
(3) The slopes of the profiles are close to the second slope of human PDL,

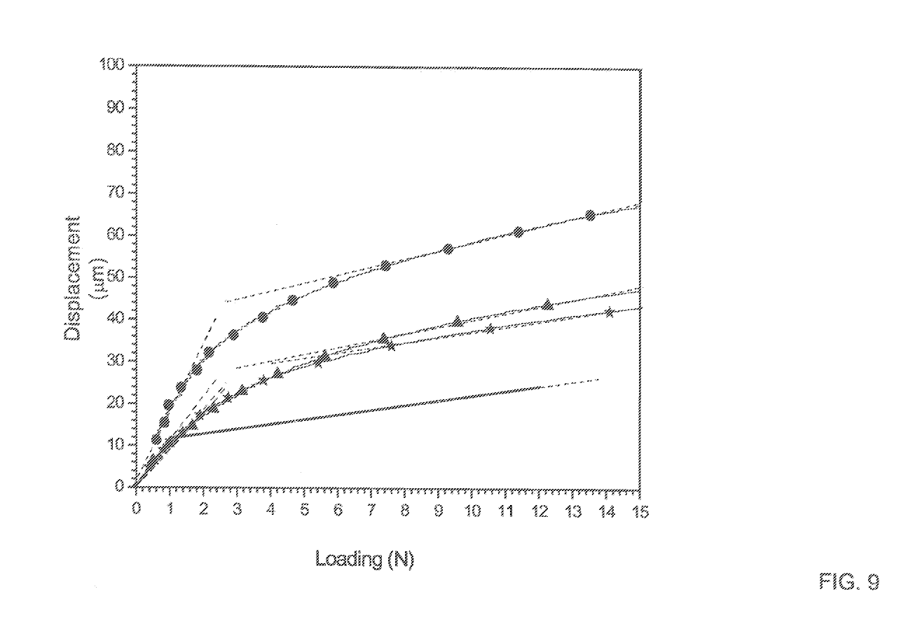

FIG. 9 shows the results of compressive testing on double cushions with same material and different thicknesses, and the results show:
(1) Each profile has substantially two slopes.
(2) The first slopes of the profiles are very similar to the first slope of human PDL, and the second slopes are very similar to the second slope of human PDL.

### REFERENCES

Berkovitz, Barry K B, Bernard J. Moxham, and Hubert N. Newman. “The periodontal ligament in health and disease.” Bookmantraa.com, 1995.
Mühlemann H R. “Ten years of tooth-mobility measurements. Journal of Periodontology.” 31 (1960):110-122.
Katona, Thomas R., et al. “Stress analysis of bone modelling response to rat molar orthodontics.” Journal of biomechanics 28.1 (1995): 27-38.
Kawarizadeh, Afshar, et al. “Correlation of stress and strain profiles and the distribution of osteoclastic cells induced by orthodontic loading in rat.” European journal of oral sciences 112.2 (2004): 140-147.
Roberts-Harry, D., and J. Sandy. “Orthodontics. Part 11: orthodontic tooth movement.” British dental journal 196.7 (2004): 391-394.
Ziros, Panos G., et al. “The bone-specific transcriptional regulator Cbfa1 is a target of mechanical signals in osteoblastic cells.” Journal of Biological Chemistry 277.26 (2002): 23934-23941.
Kawarizadeh, A., et al. “Early responses of periodontal ligament cells to mechanical stimulus in vivo.” Journal of Dental Research 84.10 (2005): 902-906.
Cowin, Stephen C. “How is a tissue built?” Journal of Biomechanical Engineering 122.6 (2000): 553-569.
Quirynen, Marc, Ignace Naert, and Daniel Van Steenberghe. “Fixture design and overload influence marginal bone loss and future success in the Brånemark® system.” Clinical oral implants research 3.3 (1992): 104-111.
Akça, Kivanç, Murat Cavit Cehreli, and Serdar Uysal. “Marginal bone loss and prosthetic maintenance of bar-retained implant-supported overdentures: a prospective study.” International Journal of Oral & Maxillofacial Implants 25.1 (2010).
Mühlemann, H R. “Periodontometry, a method for measuring tooth mobility.” Oral Surgery, Oral Medicine, Oral Pathology, Oral Radiology 4.10 (1951):1220-1233.
Walter, M., et al. “Biomechanical Models for Soft Tissue Simulation.” Esprit Series, Springer Verlag (1998).
Ona, M., and N. Wakabayashi. “Influence of alveolar support on stress in periodontal structures.” Journal of dental research 85.12 (2006): 1087-1091.
Richter, E-J., B. Orschall, and S. A. Jovanovic. “Dental implant abutment resembling the two-phase tooth mobility.” Journal of biomechanics 23.4 (1990): 297-306.
Winter, Werner, Daniel Klein, and Matthias Karl. “Micromotion of dental implants: basic mechanical considerations.” Journal of medical engineering 2013 (2012).
Sun, K. T. “The Bite Force and the Associated Influencing Factors.” Taiwan Journal of Pediatric Dentistry 3.3 (2003): 132-137.

1. A dental implant comprising:
a base member;
an abutment;
an implant-abutment junction (IAJ) portion at one end of said base member to retain said abutment to said base member, so that said abutment is able to move within a predetermined distance along an axial direction of said base member; and
a cushion means for providing a resistance force when said abutment is pressed to move relatively toward said base member in said axial direction and providing a bouncing back force when said abutment is released from said pressing,
wherein the cushion means simulates functions of natural human periodontal ligament (PDL).

2. The dental implant of claim 1, wherein the dental implant shows at least two different slopes in an axial load-displacement profile when compressed, wherein a first slope simulates desmodontal tooth movement, and a second slope simulates periodontal tooth movement of a human natural tooth.

3. The dental implant of claim 2, wherein the first slope is in a range from about 2 to 20 μm/N, preferably 5 to 20 μm/N and more preferably 7 to 15 μm/N; and the second slope is in a range from about 0.1 to 10 μm/N; preferably 0.3 to 6 μm/N and more preferably 0.6 to 3 μm/N, wherein the first slope is greater than the second slope.

4. The dental implant of claim 3, wherein the first slope is in a range from about 7 to 15 μm/N; and the second slope is in a range from about 0.6 to 3 μm/N.

5. The dental implant of claim 1, wherein the dental implant shows a vertical load-displacement profile with at least two different compressive modulus values when compressed, wherein a first modulus simulates desmodontal tooth movement, and a second modulus simulates periodontal tooth movement of a human natural tooth.

6. The dental implant of claim 5, wherein the first modulus is in a range from about 0.3-40 MPa, preferably about 0.4-20 MPa, and more preferably 1.0-10 MPa; and the second modulus is in the range from about 0.7-550 MPa, preferably about 0.9-100 MPa and more preferably about 1.0-50 MPa, wherein the second modulus is greater than the first modulus.

7. The dental implant of claim 5, wherein the first modulus is in a range from about 1.0-10 MPa; and the second modulus is in the range about 1.0-50 MPa, wherein the second modulus is greater than the first modulus.

8. The dental implant of claim 1, wherein the cushion means comprises:
a first cushion sandwiched between said IAJ portion and said abutment;
a second cushion sandwiched between said abutment and said base member only in said axial direction; and
wherein the first cushion and the second cushion are two separate members,
wherein the first cushion and the second cushion have different modulus values or different thicknesses or different modulus values and different thicknesses.

9. The dental implant of claim 8, wherein the first cushion and the second cushion are made from different elastic materials having different modulus values, wherein the first cushion has a compressive modulus about 0.3-40 MPa; and the second cushion has a compressive modulus in the range from about 0.7-550 MPa, wherein the first cushion and the second cushion both have a thickness about 0.1 mm-about 1.0 mm.

10. The dental implant of claim 8, wherein the first cushion and the second cushion are made from different elastic materials having different modulus values, wherein the first cushion has a compressive modulus about 1.0-10 MPa; and the second cushion has a compressive modulus in the range from about 1.0-50 MPa, wherein the first cushion and the second cushion both have a thickness about 0.1 mm-about 1.0 mm.

11. The dental implant of claim 9, wherein the first cushion and the second cushion both have a same thickness, and the first cushion has a compressive modulus less than that of the second cushion.

12. The dental implant of claim 8, wherein the first cushion and the second cushion have different thicknesses and are made from a same elastic material having a compressive modulus about 0.3-500 MPa; wherein the first cushion has a thickness greater than that of the second cushion, wherein the first cushion has a thickness about 0.2 mm-1.0 mm, while the second cushion has a thickness about 0.1 mm-0.6 mm.

13. The dental implant of claim 8, wherein the first cushion and the second cushion have different thicknesses and are made from a same elastic material having a compressive modulus about 1.0-50 MPa; wherein the first cushion has a thickness greater than that of the second cushion, wherein the first cushion has a thickness about 0.3 mm-0.8 mm, while the second cushion has a thickness about 0.2 mm-0.4 mm.

14. The dental implant of claim 1, wherein the cushion means comprises:
a second cushion sandwiched between said abutment and said base member only in said axial direction; and
wherein the second cushion is a composite cushion comprising materials having different modulus values.

15. The dental implant of claim 14, wherein the second cushion is a lamellar-type composite cushion comprising two layers of different elastic materials, wherein one layer has a compressive modulus about 0.3-40 MPa, and has a thickness about 0.1-1.0 mm, while another layer has a compressive modulus about 0.5-500 MPa, and has a thickness about 0.1-1.0 mm.

16. The dental implant of claim 14, wherein the second cushion is a lamellar-type composite cushion comprising two layers of different elastic materials, wherein one layer has a compressive modulus about 0.4-20 MPa, and has a thickness about 0.2-0.8 mm, while another layer has a compressive modulus about 1.0-100 MPa, and has a thickness about 0.2-0.8 mm.

17. The dental implant of claim 16, wherein said one layer is closer to said abutment than said another layer, and said one layer has a compressive modulus less than that of said another layer.

18. The dental implant of claim 1, wherein the cushion means comprises:
a first cushion sandwiched between said IAJ portion and said abutment; and
wherein the first cushion is a composite cushion comprising materials having different modulus values.

19. The dental implant of claim 18, wherein the first cushion is a lamellar-type composite cushion comprising two layers of different elastic materials, wherein one layer has a compressive modulus about 0.3-40 MPa, and has a thickness about 0.1-1.0 mm, while another layer has a compressive modulus about 0.5-500 MPa, and has a thickness about 0.1-1.0 mm.

20. The dental implant of claim 19, wherein said one layer is closer to said abutment than said another layer, and said one layer has a compressive modulus less than that of said another layer.
